(19) United States
(12) Patent Application Publication
(10) Pub. No.: US 2017/0261358 A1
(43) Pub. Date: Sep. 14, 2017

(54) ELECTROMAGNETIC FLOWMETER

(71) Applicant: Kabushiki Kaisha Toshiba, Minato-ku, Tokyo (JP)

(72) Inventors: Jun Wei Alan Toshihito CHAM, Kawasaki Kanagawa (JP); Eiji TOGASAWA, Fussa Tokyo (JP); Satoshi HOJO, Tachikawa Tokyo (JP); Hiroaki NOJIRI, Kawasaki Kanagawa (JP); Yunli LIM, Kawasaki Kanagawa (JP); Takuya IIJIMA, Ome Tokyo (JP)

(21) Appl. No.: 15/309,360

(22) PCT Filed: Dec. 16, 2014
(86) PCT No.: PCT/JP2014/083277

§ 371 Date: Nov. 7, 2016

(30) Foreign Application Priority Data
Nov. 13, 2014 (JP) 2014-230921

(51) Int. Cl. G01F 1/58

(52) U.S. Cl. CPC G01F 1/588

(57) ABSTRACT

According to one embodiment, an electromagnetic flowmeter includes, for example, a pipe, a lining, and a first double-faced tape. A fluid to be measured flows through the pipe. The lining includes a first portion which covers at least the inner face of the pipe. The first double-faced tape is placed between the inner face and the first portion to bond the pipe and the lining.

### FIELD

Embodiments of the present invention relate to an electromagnetic flowmeter.

### BACKGROUND

Conventionally, an electromagnetic flowmeter is known, in which the inner face of a pipe and the grooved end faces of flanges are integrally covered with a lining.

### CITATION LIST

### Patent Literature

Patent Literature 1: Japan Patent Application Laid-open No. 2009-288026

### SUMMARY OF THE INVENTION

### Problem to be Solved by the Invention

It is desirable, for example, to realize such an electromagnetic flowmeter with a novel and simpler configuration in which the lining can be made not to come off easily from the pipe.

### Means for Solving Problem

An electromagnetic flowmeter of embodiment comprises a pipe, a lining and a first double-faced tape. A fluid to be measured flows through the pipe. The lining includes a first portion which covers at least an inner face of the pipe. The first double-faced tape is placed between the inner face and the first portion to bond the pipe and the lining.

### BRIEF DESCRIPTION OF DRAWINGS

FIG. 1 is a perspective view of an example of an electromagnetic flowmeter according to a first embodiment.

FIG. 2 is a cross-sectional view of FIG. 1 along the II-II line.

FIG. 3 is a cross-sectional view of FIG. 2 along the III-III line.

FIG. 4 is a partially enlarged view of FIG. 2.

FIG. 5 is a cross-sectional view of an example of an electromagnetic flowmeter according to a second embodiment.

### DETAILED DESCRIPTION

Exemplary embodiments will be described below. The following embodiments will illustrate configurations and action and results (effects) resulting from the configurations by way of example. The invention can also be implemented by different configurations other than the configurations disclosed in the following embodiments. Moreover, the invention can achieve at least one of various kinds of effects (including consequential effects) obtained by the configurations.

The following embodiments include same or like constituent elements, therefore, the same or like constituent elements are given same or like reference numerals, and a redundant explanation is omitted. In the following, axial direction represents the direction along a central axis Ax of a measurement pipe 4, radial direction represents the direction along the radius of the central axis Ax, and circumferential direction represents the direction along the circumference of the central axis Ax.

### First Embodiment

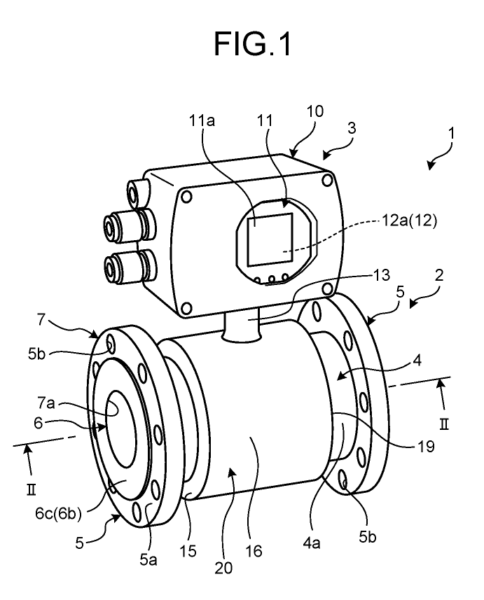

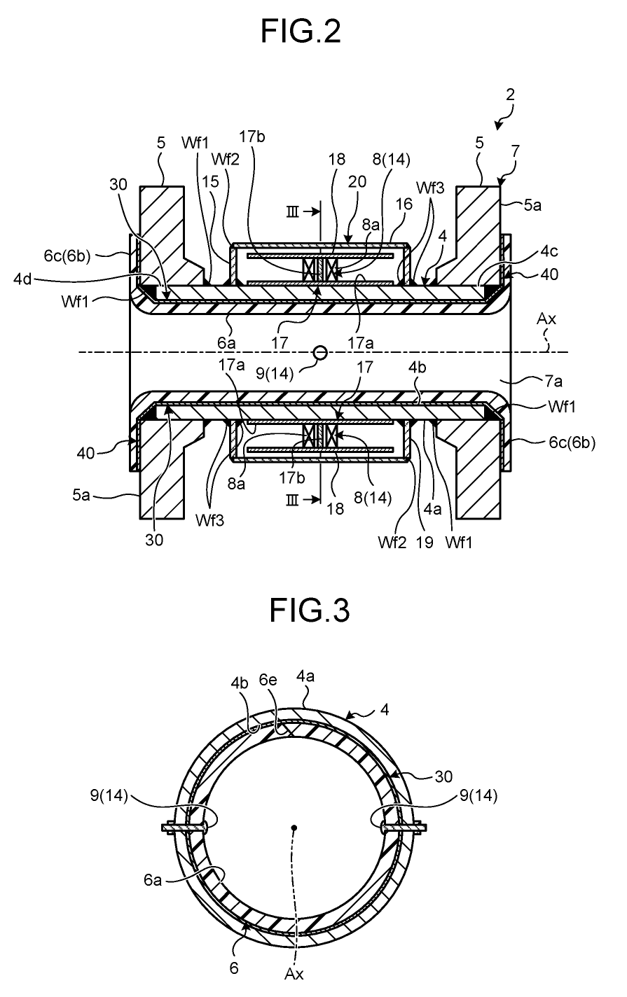

As illustrated in FIGS. 1 and 2, an electromagnetic flowmeter 1 includes, for example, a detector 2 and a converter 3 (a display device or an electronic device). The detector 2 includes a pipe 7 having an internal flow channel 7a, and a detecting element 14 (see FIG. 2) that detects a fluid to be measured which flows through the flow channel 7a. The detecting element 14 includes a pair of electrodes 9, 9 for contacting with the fluid to be measured (see FIGS. 2 and 3), and includes at least one pair of coil units 8, 8 that generates a magnetic field. The line connecting the pair of electrodes 9, 9 is substantially orthogonal to the central axis Ax (axial center, see FIGS. 2 and 3) of the pipe 7 (measurement pipe 4). The pair of coil units 8 generates a magnetic field in the direction orthogonal to the line connecting the pair of electrodes 9, 9 and the central axis Ax. The converter 3 includes a housing 10 accommodating a display 12, and a controller (not illustrated). The converter 3 is fixed on the detector 2 via a coupler 13. The coupler 13 includes a wiring (a harness or a cord) via which the converter 3 (controller) and the detector 2 (detecting element 14) are electrically connecting.

In the electromagnetic flowmeter 1, a magnetic field is generated inside the pipe 7 by the coil unit pair 8. The fluid to be measured flowing orthogonally to the magnetic field causes generation of an electromotive force in the direction orthogonal to the magnetic field and the fluid to be measured. The electromotive force attributed to the fluid to be measured is detected by the pair of electrodes 9. Then, the pair of electrodes 9 transmits a detection signal corresponding to the electromotive force to the controller of the converter 3. The controller calculates (detects) a magnitude (value) of the electromotive force from the detection signal. Moreover, the controller calculates a flow rate from the calculated magnitude of the electromotive force and displays the flow rate on the display 12 (a display screen 12a).

The display 12 includes the display screen 12a, and is supported in the housing 10 in such a manner that the display screen 12a is viewable. In the first embodiment, for example, the display 12 is contained in the housing 10 and covered with a panel 11. The panel 11 has a transparent (for example, colorless and transparent) cover 11a (a transmissive member, a translucent member, or a window) disposed thereon. The display screen 12a of the display 12 is viewed through the cover 11a. The display 12 is a liquid crystal display (LCD), for example.

As an example, the pipe 7 includes the measurement pipe 4 (pipe), flanges 5, a lining 6, and a case 20. The pipe 7 can be coupled with another pipe (a pipe to be measured, not illustrated) through which the fluid to be measured flows. The detecting element 14 and the controller detect the flow rate of the fluid to be measured from the another pipe into the pipe 7.

As an example, the measurement pipe 4 has a tubular shape (as an example, a cylindrical shape) around the central axis Ax of the pipe 7 (see FIG. 2). The measurement pipe 4 has an outer face 4a (outer periphery, outside face, face opposite the flow channel 7a, or a first face) and an inner face 4b (inner periphery, inside face, face closer to the flow channel 7a, or a second face). As illustrated in FIGS. 1 and 2, the flanges 5 and the case 20 are provided on the outer face 4a of the measurement pipe 4 while the lining 6 and the pair of electrodes 9 are provided on the inner face 4b of the measurement pipe 4. As an example, the measurement pipe 4 can be made from a nonmagnetic material such as SUS (stainless steel) or a synthetic resin material such as polyvinyl chloride.

The flanges 5 have a circular shape (as an example, an annular shape) along the outer face 4a of the measurement pipe 4. The flanges 5 are, for example, joined (secured) onto the outer face 4a of the measurement pipe 4 by welding (at welding positions Wf1 in FIG. 2). Moreover, one flange 5 is disposed at an end 4c on one side in the axial direction of the measurement pipe 4 and one flange 5 is disposed at an end 4d on the other side in the axial direction of the measurement pipe 4. The pair of flanges 5, 5 may be simply referred to as the flange 5 when they do not need to be discriminated.

The flange 5 has an end face 5a (a face or a joint face) with which an object (a flange of another pipe coupled with the pipe 7) to join is overlapped (or which opposes the object). Moreover, as illustrated in FIG. 1, the flange 5 includes a plurality of holes 5b (mount holes) that pass through the flange 5 along the axis. Not-illustrated fasteners (such as bolts) are inserted into the holes 5b for joining the pipe 7 with the object to join (the flange of another pipe coupled with the pipe 7). As an example, the flanges 5 can be made from a nonmagnetic metallic material such as SUS (stainless steel) or a synthetic resin material such as polyvinyl chloride.

The case 20 includes a wall 15 (an end plate, a vertical wall, or a first cover member), a wall 19 (an end plate, a vertical wall, or a second cover member), and a wall 16 (a peripheral wall, a cover, or a third cover member). The walls 15 and 19 are provided with a spacing in the axial direction and expand as a flange from the outer face 4a of the measurement pipe 4 in a direction intersecting with the axial direction (as an example, orthogonal direction). The wall 16 is located at the outer periphery of the walls 15 and 19 (at the end opposite the measurement pipe 4) and extends along the axis. The wall 16 is tubular (as an example, cylindrical) along the outer face 4a of the measurement pipe 4. The wall 16 extends across the walls 15 and 19, for example, and is joined (secured) onto the outer periphery of the walls 15 and 19 by welding (at welding positions Wf2 in FIG. 19). Moreover, for example, the inner periphery of the walls 15 and 19 (the end closer to the measurement pipe 4 or the end opposite the wall 16) is joined (secured) onto the outer face 4a of the measurement pipe 4 by welding (at welding positions Wf3 in FIG. 2).

The case 20 houses base members 17 (yoke members or core members), the coil units 8, and support members 18 (hold members). The wall 16 covers the base members 17, the coil units 8, and the support members 18 along the outer face 4a of the measurement pipe 4.

The base members 17 are made from, for example, a magnetic material such as iron and steel or a silicon steel sheet. The base members 17 are provided on both sides of the measurement pipe 4 across the central axis Ax radially (vertically). The pair of base members 17, 17 may be simply referred to as the base member 17 when they do not need to be discriminated.

Each base member 17 includes a first portion 17a and a second portion 17b, for instance. As viewed from the axial direction of the measurement pipe 4 (not illustrated), the first portion 17a has an arc-like shape along the outer face 4a. Moreover, the first portion 17a is as a thin plate, extending in the axial direction. For example, the first portion 17a can be joined onto the outer face 4a of the measurement pipe 4 (secured) by welding. The second portion 17b protrudes radially outward from the first portion 17a. Each of the pair of base members 17, 17 can include a number of second portions 17b corresponding to the number of coil units 8 installed in the electromagnetic flowmeter 1. For example, the second portion 17b is joined (secured) with the first portion 17a by welding or with fasteners.

Each coil unit 8 includes a cylindrical coil 8a (an exciting coil). The coil unit 8 can be formed, for example, by hardening, by impregnation, the coil 8a made of a copper wire cylindrically wound a certain (any) number of times. With the second portion 17b inserting into the pipe of the coil 8a, the coil unit 8 is attached to the base member 17. In the first embodiment, each coil unit 8 is configured of only the cylindrical coil 8a. Alternatively, for example, the coil unit 8 can be configured of a cylindrical coil bobbin and a coil wound around the coil bobbin.

As an example, the support members 18 are provided corresponding to the pair of base members 17, 17 and located opposite the first portions 17a in the coil units 8. For example, the support members 18 can be joined (secured) with the corresponding second portions 17b by welding or with fasteners. As illustrated in FIG. 2, each coil unit 8 is placed in between the first portion 17a and the support member 18. Thus, the support members 18 can prevent the coil units 8 from falling out radially from the base members 17.

The magnetic field (magnetic flux) generated inside each coil unit 8 (the second portion 17b) spreads, for example, along the outer face 4a of the measurement pipe 4 due to the first portion 17a, and flows across inside the measurement pipe 4 from one of the base member 17 toward the other base member 17. Then, the magnetic field flows from the other base member 17 into the wall 16 via gaps, flows along the circumference of the wall 16, and returns to the one base member 17 via the gaps. Thus, the electromagnetic flowmeter 1 forms such a magnetic circuit.

As illustrated in FIG. 2, the measurement pipe 4 includes the lining 6 inside. As an example, the lining 6 includes a tubular portion 6a and flare portions 6b. The tubular portion 6a is tubular (for example, cylindrical) along the inner face 4b of the measurement pipe 4 and covers the inner face 4b. The inner face of the tubular portion 6a forms the flow channel 7a. The flare portions 6b are circular (for example, plate-like and annular) along the end faces 5a of the flanges 5 and cover the end faces 5a. The flare portions 6b are provided at both axial ends of the tubular portion 6a, and project as a flange in a direction intersecting with (for example, orthogonal to) the axial direction. Moreover, as an example, the flare portions 6b can cover the end faces 5a from the inner peripheries (radial inner ends) to middle points to the outer peripheries (radial outer ends). That is, in the first embodiment, the flare portions 6b cover the end faces 5a from the inner peripheries to points before the holes 5b (see FIG. 1), and thus the holes 5b are left opened.

Each flare portion 6b has an end face 6c which opposes the end face 5a of the flange 5 and which forms the outer face of the pipe 7. The lining 6 extends across the measurement pipe 4 and the flange 5, for example. The tubular portion 6a and the flare portions 6b of the lining 6 are continuous with each other, to protect the inner face 4b of the measurement pipe 4 and the end faces 5a of the flanges 5. For example, the lining 6 can be made from a synthetic resin material such as fluorine contained resin. In the first embodiment, the tubular portion 6a represents an example of a first portion and the flare portions 6b represent an example of a second portion.

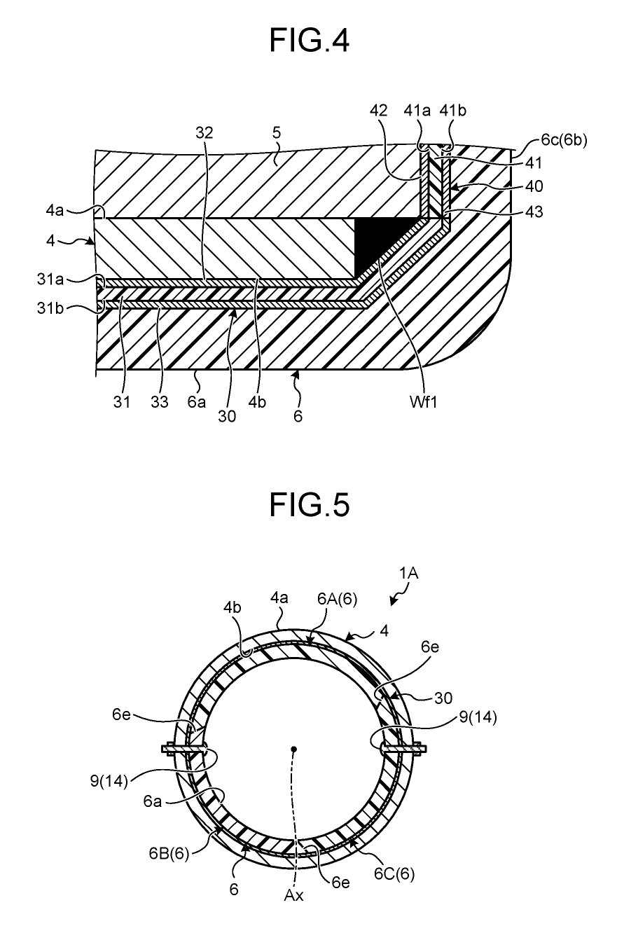

Moreover, the lining 6 is sheet-like and has a predetermined thickness. In the first embodiment, the sheet-like lining 6 is joined (i.e., bonded) with the measurement pipe 4 through a double-faced tape 30, which is provided between the inner face of the measurement pipe 4 and the tubular portion 6a of the lining 6. As illustrated in FIG. 4, the double-faced tape 30 includes a sheet-like (a thin film-like) base material 31, a first adhesive layer 32 provided on a face 31a (a first face) of the base material 31, and a second adhesive layer 33 provided on a face 31b (a second face) of the base material 31. The first adhesive layer 32 is placed between the base material 31 and the inner face 4b while the second adhesive layer 33 is placed between the base material 31 and the tubular portion 6a. Herein, the first adhesive layer 32 and the second adhesive layer 33 are formed of an anaerobic adhesive which becomes hardened by air shutoff. According to the first embodiment, the lining 6 can be attached (adhered) onto the inner face 4b of the measurement pipe 4 with the double-faced tape 30. Hence, according to the first embodiment, for example, the lining 6 can be attached (bonded) onto the measurement pipe 4 by a simpler, quicker work. Meanwhile, the first adhesion layer 32 and the second adhesion layer 33 can be modified in various ways depending on the material of the measurement pipe 4 or the lining 6. For example, the first adhesion layer 32 and the second adhesion layer 33 can be made of a silicone-based adhesive material or an epoxide-based adhesive or can be made of an instant adhesive. The base material 31 can be made from an acrylic-based resin material or a silicone-base resin material.

The double-faced tape 30 is provided as a continuous sheet with no missing portions (holes or air bubbles) across the entire inner face 4b. Thereby, the lining 6 can be further prevented from coming off from the measurement pipe 4 even if a negative pressure is occurring inside the metering pipe 4. Further, as illustrated in FIGS. 2 and 4, in the first embodiment, the double-faced tape 30 is extended over the inner face 4b and the welding portions Wf1 between the measurement pipe 4 and the flange 5 on the flow channel 7a side. That is, the welding portions Wf1 are covered with the double-faced tape 30. with no double-faced tape 30 covering the welding portions Wf1, for example, the lining 6 may be pressed onto the welding portions Wf1 by hydraulic pressure, causing unevenness corresponding to the shape of the welding portions Wf1 on the inner face (i.e., the flow channel 7a) of the lining 6. In this regard, in the first embodiment, for example, the double-faced tape 30 (the base material 31) placed in between the lining 6 and the welding portions Wf1 can prevent the formation of unevenness in the flow channel 7a. Moreover, unlike a partially provided double-faced tape 30, the double-faced tape 30 provided over the entire inner face 4b can prevent unevenness in the flow channel 7a according to the shape of the inner face 4b or by the portion of the inner face 4b with no double-faced tape 30 provided.

As illustrated in FIG. 3, the tubular portion 6a of the lining 6 is rounded cylindrically along the inner face 4b and is joined (bonded) with the inner face 4b of the measurement pipe 4. At the time of assembling the electromagnetic flowmeter 1, the lining 6 can be attached (adhered) onto the measurement pipe 4 of which the double-faced tape 30 is joined (bonded) with the inner face 4b, or the lining 6 joined (bonded) with the double-faced tape 30 can be attached (adhered) onto the inner face 4b. Such an attachment method can be arbitrarily changed according to, for example, the bore of the measurement pipe 4.

As illustrated in FIG. 3, as seen from the axial direction, both circumferential ends 6e of the tubular portion 6a are radially inclined. Thus, in the first embodiment, the inclined ends 6e of the lining 6 can prevent a flow of water from leaking from the flow channel 7a to the measurement pipe 4. Moreover, the gaps at the boundary of the ends 6e closer to the central axis Ax (radially inside) can be occluded by welding, for instance. As illustrated in FIG. 3, the pair of electrodes 9 is provided separately from the boundary of the ends 6e.

As illustrated in FIGS. 2 and 4, a double-faced tape 40 is provided in between the end faces 5a of the flanges 5 and the flare portions 6b. The double-faced tape 40 includes a sheet-like (thin film-like) base material 41, a first adhesive layer 42 provided on a face 41a (a first face) of the base material 41 and placed between the base material 41 and the end faces 5a, and a second adhesive layer 43 provided on a face 41b (a second face) of the base material 41 and placed between the base material 41 and the flare portions 6b. The base material 41, the first adhesive layer 42, and the second adhesive layer 43 can be formed of same or like materials as those of the base material 31, the first adhesive layer 32, and the second adhesive layer 33 of the double-faced tape 30.

The double-faced tape 40 is provided across the entire end faces 5a. With the double-faced tape 40 partially provided on the end faces 5a, ambient air may enter the measurement pipe 4 (between the inner face 4b and the tubular portion 6a) from the gaps between portions of the end faces 5a with no double-faced tape 40 and the flare portions 6b. In this regard, in the first embodiment, the double-faced tape 40 provided across the entire end faces 5a can easily prevent the ambient air from entering the measurement pipe 4 (between the inner face 4b and the tubular portion 6a) from the gaps between the end faces 5a and the flare portions 6b. Hence, for example, the lining 6 can be further prevented from coming off from the measurement pipe 4 even if a negative pressure is occurring inside the metering pipe 4.

For assembling the electromagnetic flowmeter 1, for example, the double-faced tape 40 is adhered in advance onto the end faces 5a of the flanges 5, and then the flare portions 6b formed by heat deformation are attached (adhered) onto the flanges 5. As the tubular portion 6a, the gaps at the boundaries of both circumferential ends 6e of each flare portion 6b can be occluded by welding, for instance. In the first embodiment, the double-faced tape 30 is an example of a first double-faced tape while the double-faced tape 40 is an example of a second double-faced tape.

As described above, in the first embodiment, for example, the electromagnetic flowmeter 1 includes the measurement pipe 4 (pipe) through which a fluid to be measured flows, the lining 6 having the tubular portion 6a (first portion) that covers at least the inner face 4b of the measurement pipe 4, and the double-faced tape 30 (first double-faced tape) placed between the inner face 4b and the tubular portion 6a to bond the measurement pipe 4 and the lining 6. Thus, according to the first embodiment, for example, by the double-faced tape 30 having a relatively simple configuration, the lining 6 can be prevented from coming off from the measurement pipe 4. This can easily realize the electromagnetic flowmeter 1 in a simpler structure and easily reduce the manufacturing time and costs for the electromagnetic flowmeter 1, for example. Moreover, for example, unlike a conventional configuration in which the lining 6 is attached to the measurement pipe 4 by transfer molding with a mold, the measurement pipe 4 and the lining 6 are joined (bonded) with each other via the double-faced tape 30. Hence, the lining 6 can be further prevented from coming off from the measurement pipe 4. Moreover, for example, as compared to a conventional configuration in which the flanges have grooved end faces, processes including blasting can be omitted, resulting in preventing occurrence of dust. Furthermore, unlike the lining 6 and the measurement pipe 4 joined (bonded) by applying a liquid adhesive with a brush, for example, unevenness in the applied adhesive can be avoided, whereby the lining 6 can be more reliably attached to the measurement pipe 4.

Moreover, in the first embodiment, for example, the electromagnetic flowmeter 1 further includes the double-faced tape 40 (second double-faced tape) placed between the end faces 5a of the flanges 5 and the flare portions 6b (second portions) of the lining 6 to bond the flanges 5 and the lining 6. Thus, according to the first embodiment, for example,

the lining 6 can be further prevented from coming off from the measurement tape 4.

Furthermore, in the first embodiment, for example, at least one (in the first embodiment, both) of the double-faced tape 30 (first double-faced tape) and the double-faced tape 40 (second double-faced tape) includes the sheet-like base materials 31 and 41, the first adhesive layers 32 and 42 provided on the faces 31a and 41a (first faces) of the base materials 31 and 41, and the second adhesive layers 33 and 43 provided on the faces 31b and 41b of the base materials 31 and 41, respectively. At least either of (in the first embodiment, both) the first adhesive layers 32 and 42 and the second adhesive layers 33 and 43 are made of an anaerobic adhesive. Hence, according to the first embodiment, for example, the lining 6 can be attached onto the measurement pipe 4 by a simpler, quicker work.

### Second Embodiment

An electromagnetic flowmeter 1A illustrated in FIG. 5 according to a second embodiment has the same configuration to the electromagnetic flowmeter 1 according to the first embodiment. Hence, the second embodiment can also achieve the same results (effects) based on the same configuration as the first embodiment.

However, in the second embodiment, as illustrated in FIG. 5, the lining 6 includes a plurality of members 6A to 6C placed adjacent to each other. More particularly, in the second embodiment, the lining 6 is made of the three members 6A, 6B, and 6C that are placed along the circumference of the measurement pipe 4. The lining 6 is attached (adhered) onto the measurement pipe 4 while the ends 6e of the adjacent members 6A to 6C abut on each other. The double-faced tapes 30 and 40 can be provided corresponding to the members 6A, 6B, and 6C. As in the first embodiment, the gaps at the boundary of the ends 6e closer to the central axis Ax (radially inside) can be occluded by welding. As illustrated in FIG. 5, the pair of electrodes 9 is provided separately from the boundary the ends 6e. Hence, according to the second embodiment, for example, as compared to the lining 6 made of a single member, the lining 6 (i.e., the members 6A to 6C) can be easily attached to the measurement pipe 4 and the flanges 5 by a simpler, more smooth, or more accurate work. The second embodiment has described an example in which the members 6A to 6C (divided members) of the lining 6 are divided in the circumferential direction. Alternatively, the members 6A to 6C can be divided in the axial direction or can be divided in the circumferential direction and the axial direction.

While certain embodiments of the invention have been described, the embodiments have been presented by way of example only, and are not intended to limit the scope of the inventions. Indeed, the above embodiments may be embodied in a variety of other forms, and, various omissions, substitutions, combinations and changes may be made without departing from the spirit of the invention. The above embodiments are included in the scope and spirit of the invention and in the accompanying claims and their equivalents. Moreover, the invention can also be implemented by configurations other than the configurations disclosed in the above embodiments, and it can achieve various effects (including consequential effects) by the fundamental configuration (technical features). Furthermore, regarding the constituent elements, the specifications (structure, type, direction, shape, size, length, width, thickness, number, arrangement, position, material, etc.) can be arbitrarily modified.

What is claimed is:

1. An electromagnetic flowmeter comprising:
a pipe through which a fluid to be measured flows;
a lining including a first portion which covers at least an inner face of the pipe; and
a first double-faced tape placed between the inner face and the first portion to bond the pipe and the lining.

2. The electromagnetic flowmeter according to claim 1, wherein
the pipe includes a flange at an end; and
the lining includes a second portion, the second portion covering an end face of the flange and continuous with the first portion,
the electromagnetic flowmeter further comprising
a second double-faced tape placed between the end face and the second portion to bond the flange and the lining.

3. The electromagnetic flowmeter according to claim 1, wherein
at least either the first double-faced tape or the second double-faced tape includes a sheet-like base material, a first adhesive layer provided on a first face of the base material, and a second adhesive layer provided on a second face of the base material; and
at least either the first adhesive layer or the second adhesive layer is made of an anaerobic adhesive.

4. The electromagnetic flowmeter according to claim 1, wherein the lining has a plurality of members arranged adjacent to each other.
